(19) United States
(12) Patent Application Publication
(10) Pub. No.: US 2009/0256370 A1
(43) Pub. Date: Oct. 15, 2009

(54) BUMPER ENERGY ABSORBERS FOR PEDESTRIAN SAFETY

(75) Inventors: Michal Siler, Kamenice (CZ); Adam J. Van Der Lelij, Vesenaz (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/419,541

(22) Filed: Apr. 7, 2009

Related U.S. Application Data
(60) Provisional application No. 61/123,600, filed on Apr. 9, 2008.

(51) Int. Cl. B60R 19/18; B60R 21/34

(52) U.S. Cl. 293/120; 293/136; 296/187.04

(57) ABSTRACT

Energy absorbers particularly well suited for use in a collision between a vehicle and a pedestrian so as to reduce collision energy transmitted to the pedestrian and having a width w, a height h, a front wall a, a top wall c and a bottom wall d such that the height is between 0.8 w and 1.0 w; the thickness of the front wall (t-a) is between 0.06 w and 0.09 w; the thickness of the top wall (t-c) is between 0.03 w and 0.09 w; the thickness of the bottom wall (t-d) is between 0.03 w an 0.09 w; and the energy absorber is made substantially of a thermoplastic material having an elongation at break higher than 20% between −20° C. and +60° C. (measured according ISO 527-1/-2); a yield strength between 30 and 40 MPa (measured according ISO 527-1/-2); modulus of elasticity between 1000-1500 MPa (measured according ISO 527-1/-2); and hardness Shore D between 50 ShD and 80 ShD (measured according ISO 868).

### FIELD OF INVENTION

The present invention relates to the field of automotive bumper assemblies for pedestrian safety, particularly to the field of energy absorbers.

### BACKGROUND OF THE INVENTION

Bumpers are used on vehicles to absorb shock and impact from collisions and to thereby prevent or minimize injury to passengers and to curtail damage to the vehicle. In addition, bumper systems are government-regulated and must meet legislated. With the aim of meeting various government test standards, particularly in Europe with the European Enhanced Vehicle-Safety Committee (EEVC) and in Japan, many improvements to bumpers are designed so that the bumper assembly provides a sufficient level of pedestrian injury mitigation and protects pedestrians' legs when struck by an automobile at a speed of 40 km/h.

Automotive bumpers typically comprise several components, separately manufactured and then assembled, which include a stiff reinforcing beam, a soft energy absorber, a lower bumper stiffener and a fascia surrounding the energy absorber and having primarily aesthetic and aerodynamic functions. The energy absorber is positioned on the front surface of the bumper beam to improve energy absorption of the bumper assembly in a pedestrian collision and also in a parking accident. It provides an initial level of energy absorption for low-speed impact, including reducing damage, and also provides a supplemental level of energy absorption during high-speed impact with a pedestrian.

Conventional energy absorbers used in automotive bumper assemblies are made from expanded polypropylene (EPP) foam or thermoplastic polymer compositions and have a large variety of shapes. Expanded polypropylene foam beads (EPP) are produced by impregnating polypropylene pellets with a volatile blowing agent in aqueous suspension under super atmospheric pressure and then reducing the pressure, whereupon the impregnated beads foam. Blowing agents used in industry are butane, dichlorodifluoromethane and carbon dioxide. This technology is time-consuming since foaming requires prolonged times in the mold due to the slow release of gases. Beyond 60-70 percent compression, foams become incompressible, requiring 30-40% in-efficient construction space. Moreover energy absorbers made of EPP foam show a highly variable energy absorption over the applicable temperature range, i.e. such energy absorbers are too stiff during cold and freezing days, and too soft during hot and summer days.

Int'l Pat. App. Pub. No. WO 2006/127242 and U.S. Pat. No. 6,726,262 disclose bumper assemblies comprising a non-foam type energy absorber, which include a frame portion having a flange and a body including a plurality of tunable crush lobes. Such absorbers are made by injection molding of a though plastic material, such as for example blends of polycarbonate (PC), polyethylene terephthalate (PET) and polybutylene terephatalate (PBT).

U.S. Pat. No. 6,923,494 discloses an energy absorber comprising a unitary molded glass mat of hermoplastic material having a plurality of outwardly extending crushable lobes and made by compression molding or thermoforming fiber reinforced resin material.

U.S. Pat. App. Pub. No. 2004/0174025 discloses a bumper assembly comprising an energy absorber having a crushable forward protecting portion which incorporates hollow primary crush members in the form of hollow protrusions and which are made by blow molding a thermoplastic polymer.

Besides safety concerns, repair costs of the vehicle and meeting government test standards are also important factors in the design of vehicle parts. In particular, vehicle parts are designed to meet government test standards, known as low speed insurance tests, whereby they withstand low speed impact, i.e., at a speed of 15 km/h.

There remains a need for vehicle energy absorbers to be made of a thermoplastic material such that they are easily manufactured, recover their original shape after a low speed impact, lead to cost savings for repairs and collision insurance and at the same time, meet government regulation standards for pedestrian protection,.

### SUMMARY OF THE INVENTION

The energy absorber described herein is an answer to the current need of a viable lower leg pedestrian protection system to meet European Directive timetable with optimum performance and cost benefits.

Described herein is an energy absorber characterized by having a width w, a height h, a front wall a, a top wall c and a bottom wall d wherein:
i) the height h is between 0.8 w and 1.0 w;
ii) a thickness of the front wall (t-a) is between 0.06 w and 0.09 w;
iii) a thickness of the top wall (t-c) is between 0.03 w and 0.09 w;
iv) a thickness of the bottom wall (t-d) is between 0.03 w and 0.09 w; and
v) the energy absorber is made substantially of a thermoplastic material having the following characteristics:
   a) elongation at break higher than 20% between −20° C. and +60° C. (measured according to ISO 527-1/-2)
   b) yield strength between 30 and 40 MPa (measured according ISO 527-1/-2)
   c) modulus of elasticity between 1000 and 1500 MPa (measured according ISO 527-1/-2)
   d) hardness Shore D between 50 ShD and 80 ShD (measured according ISO 868).

Also described herein are bumper assemblies and vehicles, which comprise the described energy absorber. Also described herein are methods of reducing collision energy transmitted to a pedestrian using the described energy absorber.

### BRIEF DESCRIPTION OF THE DRAWING

FIG. 1 is a cross section of an energy absorber comprising all parameters describing the energy absorber in which “t” designates thickness; “w” designates width; “h” designates height; “a” designates front wall; “b” designates rear wall; “c” designates top wall; “d” designates bottom wall; and “r-a”, “r-c” and “r-d” designate radii of curvature of the energy absorber.

### DETAILED DESCRIPTION OF THE INVENTION

### Definitions

The meaning of the claims should be interpreted using the following definitions:

By “front wall”, it is meant the part of the energy absorber which faces the environment, i.e. faces towards from the vehicle when the energy absorber is in a vehicle-mounted position and which wall will be impacted by the object or the pedestrian during a collision.

By “rear wall”, it is meant the part of the energy absorber which faces the interior of the vehicle when the energy absorber is in a vehicle-mounted position and which is on the opposite side of the front wall.

By “top wall”, it is meant the part of the energy absorber which faces up when it is in a vehicle-mounted position.

By “bottom wall”, it is meant the part of the energy absorber which faces down when it is in a vehicle-mounted position.

The term “vehicle” is used herein to denote a structure used for transporting persons or things and can be for example an automobile, a truck, a boat or a tractor.

The energy absorber described herein is used on a motorized vehicle so that during a collision involving the vehicle, the safety of pedestrians and the integrity of the vehicle are promoted. Preferably, the energy absorber according to the present invention is used in an automobile.

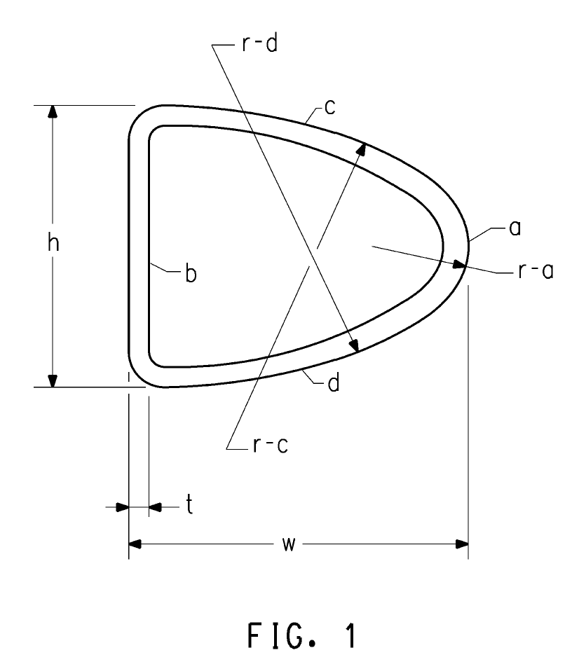

The shape, form and geometry of the energy absorber described herein can be easily varied to meet specific requirements provided that the relationships in Table 1 are satisfied, specifically, in terms of, e.g., the height (FIG. 1, h), the width (FIG. 1, w), the wall thickness (FIG. 1, t) and/or the curvature (r-x). The geometry of the energy absorber described herein may be modified to fine tune the mechanical properties and the energy absorption performance.

The thickness and curvature of the front wall (FIG. 1, a) of the energy absorber are involved in energy absorption performance, as well as the varying thickness and curvature of the top and bottom walls (FIG. 1, c and d). They define how the load is distributed over the length of the absorber and that the rapidly built-up resistance during impact allows buckling of the top and bottom walls at the right moment.

The energy absorber described herein comprises front (FIG. 1, a), top (FIG. 1, c) and bottom walls (FIG. 1, d). The energy absorber may further comprise a rear wall (FIG. 1, b). Such an energy absorber is thus a hollow body having front (FIG. 1, a), rear (FIG. 1, b), top (FIG. 1, c) and bottom walls (FIG. 1, d) that define a tubular shape.

The rear wall of the energy absorber described herein serves to circumferentially close the energy absorber, thereby leading to a D-shaped energy absorber. For this reason, the presence of a rear wall is not central to energy absorption performance. The rear wall may have the lowest wall thickness of any of the other walls to save weight and material cost, while providing a simple attachment point of the absorber to the vehicle, for example to the bumper. It may be eliminated, in which case the energy absorber has a reverse C-shape and the ends of parts c and d must be fixed directly or indirectly to the vehicle.

The thickness of the top and bottom walls (FIG. 1, c and d) is important for energy absorption performance. For this reason, when the energy absorber does not comprise a uniform thickness along its entire cross-section, the thickness of its top and bottom walls may have a non-uniform thickness between the rear and the front part of the piece. When having non-uniform top and bottom wall thicknesses, the thickness is smaller for regions nearer to the real wall of the energy absorber and gradually increases up to the value of the thickness of the front wall.

To achieve optimal energy absorption in minimal space, Table 1 gives design rules for best force-deflection behavior in the case of a collision with a pedestrian leg.

TABLE 1

| | |
|---|---|
| Required space | w |
| Height | h = 0.8 w-1.0 w |
| Radius r-a | r-a = 0.25 w-0.35 w |
| Radius r-c and r-d | r-c = r-d = 1.5 w-3.0 w |
| Thickness t-a | t-a = 0.06 w-0.09 w |
| Thickness t-b | t-b = 0.03 w-0.05 w |
| Thickness t-c and t-d | t-c = t-d = 0.03 w-0.09 w |

The wall thicknesses (t-a, t-c and t-d) of the energy absorber may be variable and preferably in the range between 2 and 6 mm, more preferably between 2.5 and 5 mm. As shown is Table 2 below, the thickness of the top and bottom walls are preferably equal, i.e. t-c=t-d. The wall thicknesses are chosen to fine tune the energy absorption; higher energy absorption requires a higher wall thickness.

Depending on the amount of energy to be absorbed by the energy absorber during impact with a pedestrian leg, (neighboring parts may also absorb energy), width w may vary from at or about 50 mm to at or about 85 mm and preferably between at or about 50 mm to at or about 70 mm. The value of the width being chosen in terms of amount of energy absorption, i.e. 100% energy absorption requires a higher width such as for example between 3 and 6 mm and a 50% energy absorption requires a width such as for example between 2 and 4.5 mm.

Also described herein is a bumper assembly comprising the energy absorber described above in conjunction with a reinforcing beam and a fascia. The energy absorber is preferably interposed between the reinforcing beam and the fascia. The beam is typically attached to vehicle rails to provide strength and rigidity to the whole system. Beam materials and fabrication techniques are selected to result in stiffness and can be chosen among for example steel, aluminum or glass mat thermoplastic (GMT). The beam can have any standard geometry as commonly understood and used by those having skill in the field, such as for example a B-section, a D-section, an I-beam or having a C or W cross-sectional shape.

The fascia is the visible exterior part of the bumper assembly and is typically made of plastic amenable to finishing utilizing conventional vehicle painting and/or coating. The fascia envelops both the energy absorber according to the present invent as well as the reinforcing beam in such a way that none of both components is visible once attached to the vehicle.

Also described herein is a motorized vehicle comprising the bumper assembly described above, which may be an automobile, a truck, a boat or a tractor.

As mentioned above, the rear wall circumferentially closes the energy absorber, which permits its simple attachment to the vehicle, such as by using self-tapping screws, screwed from the backside of the attachment plate of the vehicle, into part d of the absorber; blind rivets, used in a similar manner as self-tapping screws; or snap-fit connectors, double sided, connecting energy absorber and attachment plate, using pairs of holes in these.

In addition to the absorber's efficiency, its shape facilitates a large variety of functional integration, such as, by integrating pedestrian contact sensors or other sensors or other functional components.

The energy absorber described herein can be made of any thermoplastic resin or mixture of such resin, provided that such resins meet the following characteristics:
a) be a ductile material with an elongation at break higher than 20% between −20° C. and +60° C. (measured according to ISO 527-1/-2);
b) possess yield strength between 30 and 40 MPa (measured according to ISO 527-1/-2);
c) have a modulus of elasticity between 1000 and 1500 MPa (measured according to ISO 527-1/-2);
d) possess Hardness Shore D between 50 ShD and 80 ShD ((measured according to ISO 868).

Examples of thermoplastic resin that can be used to manufacture the energy absorber according to the present invention are polyolefins (e.g. thermoplastic polyolefinic elastomers (TPO)), polyamides (e.g. thermoplastic polyamide block copolymers (TPA)), polyesters (e.g. copolyester thermoplastic elastomers (TPC) such as for example copolyetheresters or copolyesteresters), polystyrenes (e.g. styrenic thermoplastic elastomers (TPS)), polyacetals, fluoropolymers, thermoplastic polyether or polyester polyurethanes (TPU), thermoplastic vulcanizates (TPV) and mixtures thereof.

The energy absorber described herein may preferably be of a polyester or a thermoplastic elastomers defined in ISO 18064:2003(E), such as thermoplastic polyolefinic elastomers (TPO), styrenic thermoplastic elastomers (TPS), thermoplastic polyether or polyester polyurethanes (TPU), thermoplastic vulcanizates (TPV), thermoplastic polyamide block copolymers (TPA), copolyester thermoplastic elastomers (TPC). In addition, the energy absorber is made of copolyester thermoplastic elastomers (TPC) or of polyester, polybutylene terephthalate (PBT) being especially preferred.

Thermoplastic polyolefinic elastomers (TPO's) consist of olefin type, like for example propylene or polyethylene, with a rubber. Common rubbers include EPR (ethylene-propylene rubber), EPDM (ethylene propylene diene rubber), ethylene-hexane, ethylene-octene and ethylene-butadiene.

Styrenic thermoplastic elastomers (TPS's) consist of block copolymers of polystyrene and rubbery polymeric materials like for example polybutadiene, a mixture of hydrogenated polybutadiene and polybutadiene, poly(ethylene-propylene) and hydrogenated polyisoprene.

Thermoplastic polyurethanes (TPU's) consist of linear segmented block copolymer composed of hard comprising a diisocyanate a short chain glycol and soft segments comprising diisocyanate and a long chain polyol as represented by the general formula

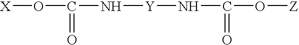

wherein
“X” represents a hard segment comprising a diisocyanate and a short-chain glycol;
“Z” represents a soft segment comprising a diisocyanate and a long-chain polyol; and
“Y” represents the residual group of the diisocyanate compound of the urethane bond linking the X and Z segments. The long-chain polyol includes those of a polyether type such as poly(alkylene oxide)glycol or those of polyester type.

Thermoplastic vulcanizates (TPV's) consist of a continuous thermoplastic phase with a phase of vulcanized elastomer dispersed therein. Vulcanizate and the phrase “vulcanizate rubber” as used herein are intended to be generic to the cured or partially cured, cross-linked or cross-linkable rubber as well as curable precursors of cross-linked rubber and as such include elastomers, gum rubbers and so-called soft vulcanizates. TPV's combine many desirable characteristics of cross-linked rubbers with some characteristics like processability of thermoplastic elastomers. There are several commercially available TPVs, for example Santoprene® and Sarlink® (TPV's based on ethylene-propylene-diene copolymer and polypropylene) which are respectively commercially available from Advanced Elastomer System's and DSM; Nextrile™ (TPV based on nitrile rubber and polypropylene) which is commercially available from Thermoplastic Rubber Systems; Zeotherm® (TPV based on acrylate elastomer and polyamide) which is commercially available from Zeon Chemicals; and DuPont™ ETPV from E. I. du Pont de Nemours and Company, which is described in WO 2004029155 (thermoplastic blends comprising from 15 to 60 wt-% of polyalkylene phthalate polyester polymer or copolymer and from 40 to 85 wt % of a cross-linkable poly(meth)acrylate or polyethylene/(meth)acrylate rubber dispersed phase, wherein the rubber is dynamically cross-linked with a peroxide free radical initiator and an organic diene co-agent).

Thermoplastic polyamide block copolymers (TPA's) consist of linear and regular chain of polyamide segments and flexible polyether or polyester segments or soft segment with both ether and ester linkages as represented by the general formula

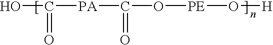

wherein
“PA” represents a linear saturated aliphatic polyamide sequence and “PE” represents for example a polyoxyalkylene sequence formed from linear or branched aliphatic polyoxyalkylene glycols or a long-chain polyol with either ether or ester or both linkages and mixtures thereof or copolyethers copolyesters derived therefrom. The softness of the copolyetheramide or the copolyesteramide block copolymer generally decreases as the relative amount of polyamide units is increased.

Polyesters are typically derived from one or more dicarboxylic acids (where herein the term “dicarboxylic acid” also refers to dicarboxylic acid derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other dicarboxylic acids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(trimethylene terephthalate) (PTT), poly(1,4-butylene terephthalate) (PBT), poly(ethylene 2,6-naphthoate), and poly(1,4-cyclohexyldimethylene terephthalate) (PCT), poly(1,4-butylene terephthalate) (PBT) being especially preferred. Preferably, thermoplastic polyesters useful for the present invention further contain impact modifier and/or plasticizer.

Copolyester thermoplastic elastomers (TPC) such as copolyetheresters or copolyesteresters are copolymers that have a multiplicity of recurring long-chain ester units and short-chain ester units joined head-to-tail through ester linkages, said long-chain ester units being represented by formula (A):

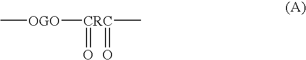

and said short-chain ester units being represented by formula (B):

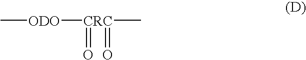

wherein
G is a divalent radical remaining after the removal of terminal hydroxyl groups from poly(alkylene oxide)glycols having preferably a number average molecular weight of between about 400 and about 6000; R is a divalent radical remaining after removal of carboxyl groups from a dicarboxylic acid having a molecular weight of less than about 300; and D is a divalent radical remaining after removal of hydroxyl groups from a diol having a molecular weight preferably less than about 250; and wherein said copolyetherester(s) preferably contain from about 15 to about 99 wt-% short-chain ester units and about 1 to about 85 wt-% long-chain ester units.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units. They are made by reacting a low molecular weight diol or a mixture of diols with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, and a more preferred diol is 1,4-butanediol.

The material used to manufacture the energy absorber described herein may comprise other additives including plasticizers; stabilizers; antioxidants; ultraviolet absorbers; hydrolytic stabilizers; anti-static agents; dyes or pigments; fillers, fire-retardants; lubricants; reinforcing agents such as fibers, flakes or particles of glass; minerals, ceramics, carbon among others, including nano-scale particles; processing aids, for example release agents; and/or mixtures thereof. Suitable levels of these additives and methods of incorporating these additives into thermoplastic resin compositions are known to those of skill in the art.

The energy absorber described herein may be manufactured by using any known melt-processing means such as injection molding, blow molding and extrusion, extrusion being preferred. Injection molding is a conventional technique used for manufacturing plastic parts, wherein molten plastic is injected at a high pressure into a mold having the shape of interest.

During blow molding, typically a parison of plastic material that has been produced by extrusion or injection molding and which is in a hot moldable condition is positioned between two halves of an open blow mold having a mold cavity of a shape appropriate to the required external shape of the article to be manufactured. The parison gradually descends and stretches under the influence of gravity. When the parison reaches the proper length, the mold halves are closed around it, the end of the hollow parison are sealed and the article may be manufactured either by a) pressurized air (or other compressed gas) which is introduced in the interior of the parison to inflate it to the shape of mold or to expand it against the sides of the mold cavity or b) vacuum expansion against the surface of the mold cavity. After a cooling period, the mold is opened and the blow molded article is ejected.

Other variants of blow molding process are well-known in the art, including, without limitation, suction blow molding, co-extrusion blow molding, sequential blow molding, processes involving parison manipulation or laying down, and combinations of two or more of these processes. When a suction blow molding process is used, the mold is already closed; the parison enters into the mold through an opening at the top surface moves through the mold cavity by suction, generally with the help of an additional flow of gas.

Extrusion is a conventional technique used for manufacturing articles of arbitrary lengths. Extrusion is the preferred manufacturing process of the energy absorber described herein. Relative to blow molding and injection molding, extrusion does not require a mold, which reduces cost, increases productivity and promotes freedom of length of manufactured product. During the extrusion process, thermoplastic resin is extruded in a hot moldable state through the gap between the pin and the die of an extrusion head. The pin and die are shaped to produce the desired shape and cross-section to hollow parts of interest. After exiting the die assembly, the melt may be drawn to a thinner cross section through an air gap. The melt is then cooled, its shape is maintained and the energy absorber is cut to the desired length.

The energy absorber described herein is designed to protect not only pedestrians struck by a moving vehicle—which protection is regulated more specifically—but also to maintain structural integrity of the colliding vehicle. The absorber described herein facilitates reducing the packaging space (related to w) in the bumper assembly by up to about 30% relative to conventional energy absorbers, thereby providing a strong advantage in terms of vehicle design. Because of the nature of the thermoplastic resin used to manufacture the energy absorber described herein, this absorber exhibits an energy absorption over temperature ranges (−20° C. to +60° C.) that is more uniform than that of conventional energy absorbers made of EPP. By recovering its original shape after a low speed impact and retaining sufficient integrity to withstand subsequent impact, this energy absorber is easier and cheaper to to repair, which promotes savings on collision insurance.

### EXAMPLES

The invention is further illustrated in the Examples below.

The following material was used for energy absorbers described herein. An unreinforced supertough polybutylene terephthalate composition was used to manufacture energy absorbers described herein. Such composition comprised about 75 wt-% of polybutylene terephthalate (with a melt flow rate of 9 dg/min as determined at 250° C. under 2.16 kg load), about 16 wt-% of a terpolymer of ethylene/30% ethyl acrylate/2% maleic anhydride methacrylate having a melt flow rate of 7 dg/min at 190° C. under 2.16 kg load, about 4 wt-% of a terpolymer of ethylene/25% methyl acrylate/6.5% glycidyl methacrylate having a melt flow rate of 6 dg/min at 190° C. under 2.16 kg load, and the remaining 5 wt-% being common additives and stabilisers such as carbon black, antioxidants, lubricants, catalysts and melt stabilisers.

Such a composition has the following characteristics: elongation at break: >100%; yield strength: 34 MPa; modulus of elasticity 1400 MPa. Ten specimens of energy absorbers having a D-shape and being made of the polyester described above were manufactured by using an extrusion line (Egan single screw extruder (diameter: 63.5−L/D=24:1), a spider extrusion head fitted with the specific die, the calibration and cooling unit (Floataire 125-30) and a haul off unit (Graewe B63S). Pellets of a polybutylene terephthalate polymer were first dried at 110° C. for 4 hours to achieve a moisture content below 0.04% and then fed into the single screw extruder having barrel temperatures set from 225° C. to about 245° C.

The process melting temperature was around 250° C. for a line speed of 0.5 m/mmin. After being shaped and cooled in the vacuum calibration water tank, the profile was taken off and then cut to size. The mean temperature of the polymer dropped below the particular solidification temperature of the melt as it passed through this section. The forming of the profile was achieved by heating the hollow D shape and progressively forming it with a desired curvature. The dimensions of the energy absorber are given in Table 2.

TABLE 2

| width w | 58 mm | |
|---|---|---|
| height h | 47 mm | 0.81 |
| thickness t-a | 5.2 mm | 0.089 |
| thickness t-b | 2.8 mm | 0.048 |
| thickness t-c | 1.9 mm | 0.033 |
| thickness t-d | 1.9 mm | 0.033 |

The performance of new cars in terms of pedestrian safety is measured by specific tests defined by the European Commission under the EC directory 2003/102/EC. The Working Group 17 of the European Enhanced Vehicle Committee (EEVC) defines the testing procedure. EuroNCAP evaluates cars including a pedestrian safety test and informs consumers about the results. The energy absorber described herein was tested according to the EC Directory 2003/102/EC and EuroNCAP. Legislation requirement and results are given in Table 3.

TABLE 3

| | Lower Leg Test | | | | |
|---|---|---|---|---|---|
| | Criteria Results at 40 km/h | | | | |
| | | | | Energy absorber | |
| | Legislation | | | described herein | |
| | EC | EC | | Position | |
| | Phase 1 | Phase 2 | EuroNCAP | Z = | Position |
| | legislation | legislation | requirement | +20 mm | Z = 0 |
| Maximum | 200 | 170 | 150 | 162 | 154 |
| acceleration (g) | | | | | |
| Maximum | 21 | 19 | 15 | 13 | 15 |
| dynamic knee | | | | | |
| bending angle | | | | | |
| (°) | | | | | |
| Maximum | 6 | 6 | 6 | 4 | 5 |
| dynamic knee | | | | | |
| shearing (mm) | | | | | |

The position in the Z-axis differs by 20 mm. The lower leg beam impactor was lifted by 20 mm upwards in the test marked as “Position Z=+20 mm”). The energy absorber in the tested bumper fulfils the current legislation and also most likely will fulfils the future requirements.

What is claimed is:

1. An energy absorber having a width w, a height h, a front wall a, a top wall c and a bottom wall d wherein:
1) the height h is between 0.8 w and 1.0 w;
2) a thickness of the front wall (t-a) is between 0.06 w and 0.09 w;
3) a thickness of the top wall (t-c) is between 0.03 w and 0.09 w;
4) a thickness of the bottom wall (t-d) is between 0.03 w an 0.09 w; and
5) the energy absorber is made substantially of a thermoplastic material having the following:
a) elongation at break higher than 20% between −20° C. and +60° C. (measured according ISO 527-1/-2);
b) yield strength between 30 and 40 MPa (measured according ISO 527-1/-2);
c) modulus of elasticity between 1000-1500 MPa (measured according ISO 527-1/-2); and
d) hardness Shore D between 50 ShD and 80 ShD (measured according ISO 868).

2. The energy absorber of claim 1, wherein the thickness of the top wall (t-c) and the thickness of the bottom wall (t-d) are equal.

3. The energy absorber of any preceding, further comprising a rear wall (b) that circumferentially closes the energy absorber.

4. The energy absorber of any preceding claim, further comprising a rear wall (b) that circumferentially closes the energy absorber.

5. The energy absorber of any preceding claim, wherein the rear wall (b) has a thickness (t-b) between 0.03 w and 0.05 w.

6. The energy absorber of any preceding claim, wherein the thickness is variable and is between at or about 2 mm and at or about 6 mm.

7. The energy absorber of any preceding claim, wherein the thermoplastic material is made of a polyester or thermoplastic elastomers defined in ISO 18064:2003(E).

8. The energy absorber of any preceding claim, wherein the thermoplastic material is polybutylene terephthalate (PBT).

9. The energy absorber of any preceding claim, made by injection molding, blow molding or extrusion.

10. The energy absorber of claim 9 made by extrusion.

11. A bumper assembly comprising the energy absorber of claim 1, a reinforcing beam and a fascia, the energy absorber being interposed between the reinforcing beam and the fascia.

12. A vehicle having the bumper assembly of claim 11, wherein the vehicle is selected from the group consisting of a motorized vehicle, an automobile and a truck.

13. A method of reducing collision energy transmitted to a pedestrian comprising the step of: attaching the energy absorber of claim 1 to a vehicle selected from the group consisting of a motorized vehicle, an automobile and a truck.
